(19) United States
(12) Patent Application Publication
(10) Pub. No.: US 2012/0027281 A1
(43) Pub. Date: Feb. 2, 2012

(54) METHOD AND APPARATUS FOR PROCESSING IMAGE, AND MEDICAL IMAGE SYSTEM EMPLOYING THE APPARATUS

(76) Inventors: Kwang-eun Jang, Busan (KR); Jong-ha Lee, Hwaseong-si (KR); Kang-eui Lee, Yongin-si (KR); Young-hun Sung, Hwaseong-si (KR)

(21) Appl. No.: 13/193,859

(22) Filed: Jul. 29, 2011

(30) Foreign Application Priority Data
Jul. 29, 2010 (KR) 10-2010-0073721

(51) Int. Cl. G06K 9/00

(52) U.S. Cl. 382/131

(57) ABSTRACT

A method of processing an image is provided. The method includes generating a first intermediate reconstructed image by applying a first iterated reconstruction algorithm to a tomographic image of a predetermined subject; generating a second intermediate reconstructed image by applying a second iterated reconstruction algorithm to a difference image between the first intermediate reconstructed image and the tomographic image; and generating an ultimately reconstructed image by composing the first and second intermediate reconstructed images.

### CROSS-REFERENCE TO RELATED APPLICATIONS

This application claims the benefit of Korean Patent Application No. 10-2010-0073721, filed on Jul. 29, 2010, in the Korean Intellectual Property Office, the entire disclosure of which is incorporated herein by reference for all purposes.

### BACKGROUND

1. Field

The following disclosure relates to methods and apparatuses for processing an image, and medical image systems employing the apparatuses.

2. Description of the Related Art

Currently, X-ray mammography is the most broadly used image processing technique regarding organs of a human body, e.g., breast tissues. In particular, full field digital mammography (FFDM) is very economical and is capable of detecting very small microcalcification tissues. Meanwhile, the performance of X-ray mammography is low in detecting mass that is one of popular lesions. Since a radiation image of a breast is obtained by compressing tissues in the breast and then two-dimensionally projecting a radiation on the breast, in particular, if the breast has a high density as illustrated in FIG. 1, tissues overlap each other and thus accuracy of diagnosis is reduced.

Unlike a mammography method, a digital breast tomosynthesis (DBT) method may solve the problem of overlapping tissues to a certain degree by capturing images of a subject such as a breast at a plurality of different angles (e.g., 7 through 30 different angles).

A computerized tomography (CT) method obtains projection data at angles equal to or greater than 180° and thus may accurately reconstruct a three-dimensional (3D) image. In this case, as a representative reconstruction algorithm, in a filtered backprojecion (FBP) algorithm, simple filtering is performed in a Fourier domain and then divided images are recombined in an image domain.

A tomosynthesis method obtains an image in a limited range of angles and thus loses information.

### SUMMARY

Provided are methods and apparatuses for processing an image, capable of minimizing loss of information in an ultimately reconstructed image by applying two iterated reconstruction algorithms having different properties to a tomographic image obtained in a limited range of angles.

Provided are methods and apparatuses for processing an image by iteratively performing an update method induced from a data obtaining model of an X-ray, and rapidly removing noise by using a gradient-based total variation regularization method.

Provided are methods and apparatuses for processing an image to obtain an ultimately reconstructed image by updating an auxiliary variable of an image by using a Poisson model and a total variation regularization method a plurality of times.

Provided are medical image systems employing the apparatuses.

Additional aspects will be set forth in part in the description which follows and, in part, will be apparent from the description, or may be learned by practice of the presented embodiments.

According to an aspect of the present invention, a method of processing an image is provided. The method includes generating a first intermediate reconstructed image by applying a first iterated reconstruction algorithm to a tomographic image of a predetermined subject; generating a second intermediate reconstructed image by applying a second iterated reconstruction algorithm to a difference image between the first intermediate reconstructed image and the tomographic image; and generating an ultimately reconstructed image by composing the first and second intermediate reconstructed images.

According to another aspect of the present invention, an apparatus for processing an image is provided. The apparatus includes a first intermediate reconstructed image generation unit to generate a first intermediate reconstructed image by applying a first iterated reconstruction algorithm to a tomographic image of a predetermined subject; a second intermediate reconstructed image generation unit to generate a second intermediate reconstructed image by applying a second iterated reconstruction algorithm to a difference image between the first intermediate reconstructed image and the tomographic image; and a composition unit to generate an ultimately reconstructed image by composing the first and second intermediate reconstructed images.

The first iterated reconstruction algorithm may be a wavelet-based iterated shrinkage algorithm, a maximum likelihood-expectation maximization (ML-EM) algorithm, a maximum likelihood (ML)-convex algorithm, a simultaneous algebraic reconstruction technique (SART) algorithm, or an algebraic reconstruction technique (ART) algorithm.

The second iterated reconstruction algorithm may be a total variation regularized reconstruction algorithm.

The second intermediate reconstructed image may be generated by re-projecting and transforming the first intermediate reconstructed image into a sonogram; generating a difference image by calculating a difference between data extracted from the sonogram and the tomographic image; setting an initial guess of a signal to be reconstructed, by performing backprojecion on the difference image; and generating the second intermediate reconstructed image including edge components by applying the second iterated reconstruction algorithm to the difference image.

The difference image may include noise components, artifact components, and detailed information not reconstructed from the first intermediate reconstructed image.

The ultimately reconstructed image may be generated by calculating a weighted sum of the first and second intermediate reconstructed images, or by dividing the first and second intermediate reconstructed images into sub-bands by performing directional wavelet transformation, and then combining the sub-bands.

According to another aspect of the present invention, a method of processing an image is provided. The method includes calculating an initial value of a tomographic image of a predetermined subject; updating the initial guess by using an update method induced from a data obtaining model of an X-ray, and rapidly removing noise by using a gradient-based total variation regularization method; and iterating the updating and the rapid removing.

The update method induced from the data obtaining model of the X-ray may be a maximum likelihood-expectation maximization (ML-EM) algorithm, a maximum likelihood (ML)-convex algorithm, a simultaneous algebraic reconstruction technique (SART) algorithm, or an algebraic reconstruction technique (ART) algorithm.

According to another aspect of the present invention, a method of processing an image is provided. The method includes calculating an initial guess of a tomographic image of a predetermined subject; initializing an auxiliary variable; calculating a weight and an error based on a measurement value; applying a divergence operator to the auxiliary variable; performing differential calculation between the error and a result of multiplying a result of the previous step by an appropriate weight; multiplying a result of the previous operation by the weight; applying a gradient operator to a result of the previous operation; updating the auxiliary variable by summing the auxiliary variable and a result of multiplying a result of the previous operation by a predetermined weight; iterating the above operations; and calculating an ultimate measurement value from the updated auxiliary variable.

The calculating of the weight and the error may be based on a maximum likelihood-expectation maximization (ML-EM) algorithm or a maximum likelihood (ML)-convex algorithm.

According to another aspect of the present invention, a medical image system employs the apparatus.

The medical image system may further include a tomography unit for obtaining the tomographic image of the predetermined subject.

The medical image system may further include a storage unit to store the generated ultimately reconstructed image, or to store diagnosis information obtained from the generated ultimately reconstructed image, in correspondence with the ultimately reconstructed image.

The medical image system may further include a communication unit to transmit the generated ultimately reconstructed image, or to transmit diagnosis information obtained from the generated ultimately reconstructed image, in correspondence with the ultimately reconstructed image.

Other features and aspects may be apparent from the following detailed description, the drawings, and the claims.

### BRIEF DESCRIPTION OF THE DRAWINGS

FIG. 1 is a radiation image illustrating an example of dense breast tissues;

FIG. 2 is an image illustrating an example when data obtained by using a tomosynthesis method is represented in a Fourier domain;

FIG. 3 is a block diagram illustrating a medical image system according to an example embodiment;

FIG. 4 is a block diagram illustrating an apparatus for processing an image according to an example embodiment;

FIG. 5 is a flowchart illustrating a method of processing an image, according to an example embodiment; and

FIG. 6 is a flowchart illustrating a method of processing an image, according to another example embodiment.

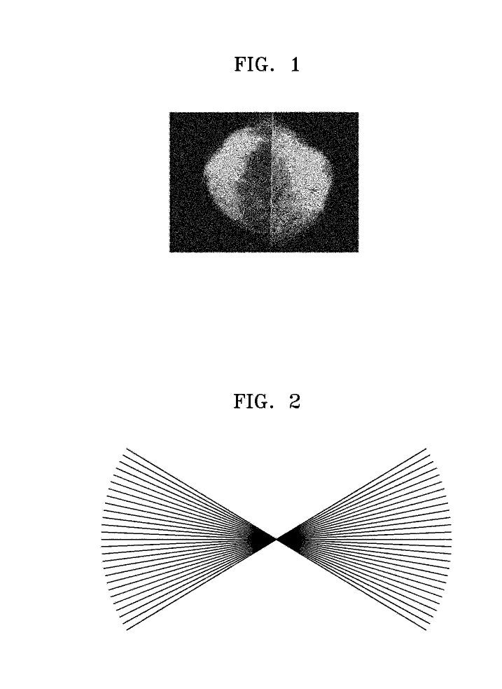

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary, skill in the art. Also, descriptions of well-known functions and constructions may be omitted for increased clarity and conciseness.

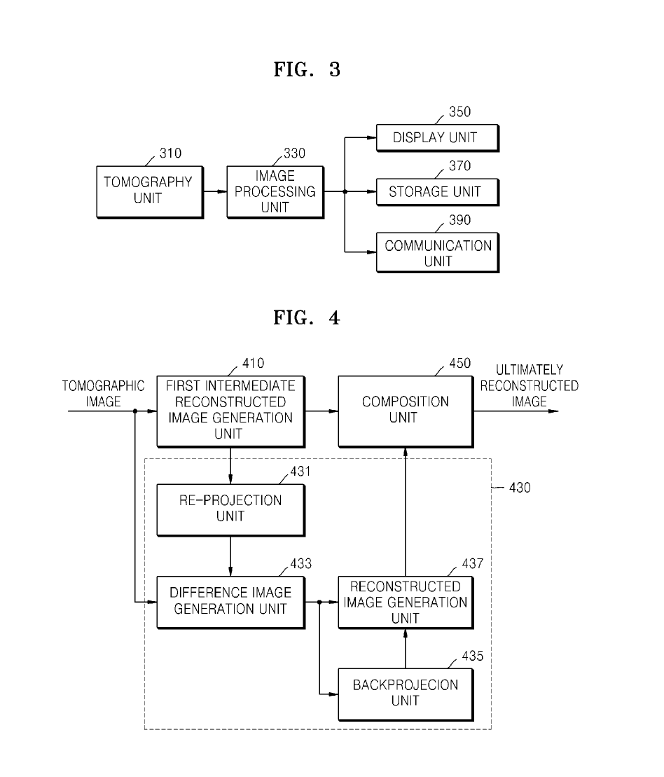

FIG. 2 is an image illustrating an example when data obtained by using a tomosynthesis method is represented in a Fourier domain. As illustrated in FIG. 2, the data obtained by using a tomosynthesis method may be represented as lines in the Fourier domain due to a Fourier slice theorem. In this case, spaces having no line are portions that fail to obtain information, and thus serious artifacts may occur due to aliasing.

Meanwhile, a compressed sensing method may use piecewise continuity of an image signal.

There are two methods to apply the compressed sensing methods to the field of image processing. In one method, sparsity of an image signal is used, which is observed in a sparsifying transform domain such as a discrete cosine transform (DCT) domain or a wavelet transform domain. Since an image signal has piecewise continuity, information is limited to some coefficients in the DCT domain or the wavelet transformation domain. That is, in one image transformed to a frequency region, most DCT coefficients or wavelet transformation coefficients have a value ‘0’, while only some coefficients having information have values other than ‘0’. By using this property, image compression using the JPEG or JPEG2000 standards is enabled. Applying of sparsity to reconstruct a three-dimensional (3D) image in a tomography method is the same as finding a solution of an optimization problem represented in Equation 1.

$$\hat{x} = {argmin}_{x} \frac{1}{2} {‖ y - AD α ‖}^{2} + λ {‖ α ‖}_{p}^{p} \qquad 〈 Equation 1 〉$$

Here, α represents a coefficient in a transformation domain, D is a sparsifying transformation operator, and A is an operator capable of explaining projection physics, i.e., Radon transformation. Y is measured data, and λ is a regularization parameter for regularizing sparsity of α. In particular, an optimization problem when p has a value ‘1’ is referred to as an L1 minimization problem.

In the other method, a total variation function is used. The total variation function is the same as a method of finding a solution of an optimization problem represented in Equation 2.

$$\hat{x} = {argmin}_{x} {‖ y - Ax ‖}^{2} + 2 λ {‖ x ‖}_{TV} \qquad 〈 Equation 2 〉$$

As in Equation 1, A is an operator capable of explaining projection physics, i.e., Radon transformation, Y is measured data, and λ is a regularization parameter for regularizing a total variation TV of x. Unlike Equation 1 representing an indirect measuring method of calculating the coefficient α in the transformation domain, Equation 2 represents a direct measuring method of directly calculating x.

Meanwhile, TV(x) in Equation 2 is mostly calculated as represented in Equation 3 or Equation 4.

$$\begin{matrix}x ∈ {ℝ}^{m \times n} \cdot {TV}_{l} ( x ) = {\sum }_{i = 1}^{m - 1} {\sum }_{j = 1}^{n - 1} \sqrt{{( {x}_{i , j} - {x}_{i + 1 , j} )}^{2} + {( {x}_{i , j} - {x}_{i , j - 1} )}^{2}} + {\sum }_{i = 1}^{m - 1} \vert {x}_{i , j} - {x}_{i + 1 , n} \vert + {\sum }_{j = 1}^{n - 1} \vert {x}_{m , j} - {x}_{m , j + 1} \vert & 〈 Equation 3 〉 \\ x ∈ {ℝ}^{m \times n} \cdot {TV}_{{t}_{1}} ( x ) = {\sum }_{i = 1}^{m - 1} {\sum }_{j = 1}^{n - 1} \{ \vert {x}_{i , j} - {x}_{i + 1 , j} \vert + \vert {x}_{i , j} - {x}_{i , j + 1} \vert \} + {\sum }_{i = 1}^{m - 1} \vert {x}_{i , n} - {x}_{i + 1 , n} \vert + {\sum }_{j = 1}^{n - 1} \vert {x}_{m , j} - {x}_{m , j + 1} \vert & 〈 Equation 4 〉\end{matrix}$$

The most efficient method of calculating Equation 1 may be a matching pursuit method for finding a solution by increasing a non-zero value of a coefficient (α in Equation 1) by one. However, the matching pursuit method has a low processing speed and requires a high-capacity memory. Also, since a model equation is represented as matrix multiplication like ‘HD’ in Equation 1, each column of a matrix has to be accessible. If wavelet transformation or DCT is used as sparsifying transformation, D is a reconstruction operator of wavelet transformation or DCT.

Meanwhile, another method of solving an L1 minimization problem such as Equation 1 may be an algorithm using a gradient method. This algorithm is an iterated method of updating a solution by using a gradient, and then correcting the solution by performing simple thresholding/shrinkage. This method is also referred to as an iterated shrinkage algorithm, and may representatively include a separable surrogate function (SSF).

As an example of a wavelet-based iterated shrinkage algorithm, the SSF may update the coefficient α by using a method represented in Equation 5.

$${α}_{i + 1} = {S}_{T} ( \frac{1}{c} {( AD )}^{T} ( x - {AD}_{{α}_{i}} ) + {α}_{i} ) \qquad 〈 Equation 5 〉$$

Here, S( ) is a shrinkage function and is a simple operator for making a coefficient less than a threshold value T determined by λ and p in Equation 1, into a value ‘0’. C is a constant related to a norm of an operator AD, and is a parameter for regularizing a degree of updating.

If the above algorithm may be applied to a tomographic image obtained in a limited range of angles, a high-quality 3D image may be rapidly achieved even without an appropriate initial guess. Also, noise may be prevented and artifacts caused by lack of view information may be greatly reduced. However, since a gradient in a transformation domain is based, edge information may be lost a lot and distortion similar to a Gibbs phenomenon may occur.

If an image signal is directly measured, rather than indirectly measured, in the transformation domain, the loss of edge information or the distortion due to a Gibbs phenomenon may be reduced. For this, Equation 2 has to be solved. A method of solving Equation 2 is similar to a method induced by Equation 5. A polynomial in the function S( ) of Equation 5 may correspond to a descending process for updating a solution by using a gradient, and the function S( ) may correspond to a soft-thresholding noise suppression method.

\hat{x}ₖ+1=\hat{x}ₖ+cA^{T}(y−A\hat{x}ₖ) <Equation 6>

That is, after a solution is updated by using a gradient, a noise suppression method may be applied to an updating result. If Equation 2 is used, unlike Equation 5, a noise suppression method for minimizing a total variation TV may be used.

However, due to a very large amount of data in a tomography reconstruction problem, noise may not be easily suppressed by using a well-known total variation minimization method. However, since a gradient exists in a dual problem of a total variation minimization problem, a total variation minimization method based on a gradient may be used.

X is ultimately calculated by iteratively updating an auxiliary variable capable of explaining x for solving the dual problem of the total variation minimization problem. The following descriptions are made on the assumption of a two-dimensional (2D) image, but may be expanded to a higher-dimensional image.

It is assumed that p is a set of matrix pairs (p, q) satisfying the following condition. (p, q) is a matrix that satisfies pε [symbol] (m−1)×n and pε [symbol] (m−1)×n. Numbers in (p, q) have to satisfy the following condition.

p_{i,j}²q_{i,j}²≦1,i=1, . . . ,(m−1),j=1, . . . ,(n−1)|p_{i,j}|≦1,|q_{i,j}|≦1 <Equation 7>

Gradient and divergence operators regarding a discrete signal are defined as represented in Equation 8.

The divergence operator regarding (p, q):

[symbol]

(p,q)→ [symbol] m×n, [symbol] (p,q)_{i,j}=p_{i,j}−p_{i-1,j}+q_{i,j}−q_{i,j-1} <Equation 8>

The gradient operator regarding x:

$${ℒ}^{T} ( x ) = ( p , q ) , \\ \begin{matrix}{p}_{i , j} = {x}_{i , j} - {x}_{i + 1 , j} \\ {q}_{i , j} = {x}_{i , j} - {x}_{i , j + 1}\end{matrix}$$

In order to solve the noise suppression problem, A in Equation 2 is regarded as an identity operator, and auxiliary variables p and q are updated by using the following method.

$$( {p}_{k}^{′} , {q}_{k}^{′} ) = ( {p}_{k - 1} , {q}_{k - 1} ) + \frac{⊥}{8 λ} {ℒ}^{T} ( \hat{y} - λℒ ( {p}_{k - 1} , {q}_{k - 1} ) ) \\ ( {p}_{k} , {q}_{k} ) = {P}_{𝒫} ( ( {p}_{k}^{′} , {q}_{k}^{′} ) ) . \qquad 〈 Equation 9 〉$$

[symbol] ( ) is a function for projecting (pₖ¹, qₖ¹) on the condition of Equation 6. In Equation 9, ŷ is a noise suppression target. If Equations 6 and 9 are iteratively applied, consequently, Equation 2 is solved.

Meanwhile, in order to apply a duality-based total variation regularized reconstruction algorithm to a field of tomography, an initial guess has to be appropriate and scaling needs to be performed in accordance with an actual signal size. Also, a performance of reconstructing edge components of an image may be excellent but a contrast of the whole image may become flat.

FIG. 3 is a block diagram illustrating a medical image system according to an example embodiment. The medical image system may include a tomography unit 310, an image processing unit 330, a display unit 350, a storage unit 370, and a communication unit 390. In this example, the medical image system may be implemented by using only the image processing unit 330. That is, the tomography unit 310, the display unit 350, the storage 370, and the communication unit 390 may be optionally included. Meanwhile, the image processing unit 330 may be implemented as at least one processor.

Referring to FIG. 3, the tomography unit 310 captures a tomographic image of a subject. Meanwhile, if the tomography unit 310 is not included in the medical image system, a tomographic image provided from outside the medical image system is input to the image processing unit 330.

The image processing unit 330 generates a first intermediate reconstructed image by applying a first iterated reconstruction algorithm to the tomographic image provided from the tomography unit 310 or outside the image processing unit 330, generates a second intermediate reconstructed image by applying a second iterated reconstruction algorithm to a difference image between the first intermediate reconstructed image and the tomographic image, and generates an ultimately reconstructed image by composing the first and second intermediate reconstructed images.

Meanwhile, the image processing unit 330 may perform noise reduction on the tomographic image, or may perform noise reduction and/or contrast enhancement on the first or second intermediate reconstructed image. Meanwhile, the image processing unit 330 may also have an image reading function, and thus may obtain required diagnosis information from the ultimately reconstructed image.

The display unit 350 may be implemented as, for example, a monitor, and may display the ultimately reconstructed image generated by the image processing unit 330, or may display the diagnosis information together with ultimately reconstructed image.

The storage 370 may be implemented as, for example, memory, and may store ultimately reconstructed image generated by the image processing unit 330, or may store the diagnosis information obtained by the image processing unit 330, in correspondence with the ultimately reconstructed image.

The communication unit 390 may transmit by a wired or wireless network the ultimately reconstructed image generated by the image processing unit 330, or the ultimately reconstructed image combined with the diagnosis information, to another medical image system located at a remote place or a specialist such as a doctor at a hospital, or may receive and input the tomographic image provided from outside the medical image system, to the image processing unit 330. In particular, the communication unit 390 may transmit by wire or wirelessly the ultimately reconstructed image, or the ultimately reconstructed image combined with the diagnosis information, to another medical image system or a specialist who has transmitted the tomographic image.

Meanwhile, the storage 370 and the communication unit 390 may be integrated into a picture archiving communication system (PACS) by adding image reading and searching functions.

Alternatively, the image processing unit 330, the storage 370, and the communication unit 390 may be integrated into a PACS.

Meanwhile, the medical image system may be any image diagnostic system using tomography.

FIG. 4 is a block diagram of an apparatus for processing an image, according to an embodiment of the present invention. The image processing apparatus may efficiently combine and use a wavelet-based iterated shrinkage algorithm and a duality-based total variation regularized reconstruction algorithm. Since a gradient method is used, both of these algorithms may have a simple calculation process, and may be modeled by using an operator equation instead of a matrix equation. Meanwhile, weaknesses of the wavelet-based iterated shrinkage algorithm and the duality-based total variation regularized reconstruction algorithm complement each other.

The image processing apparatus may include a first intermediate reconstructed image generation unit 410, a second intermediate reconstructed image generation unit 430, and a composition unit 450. In this example, the first intermediate reconstructed image generation unit 410, the second intermediate reconstructed image generation unit 430, and the composition unit 450 may be implemented as at least one processor. Meanwhile, the second intermediate reconstructed image generation unit 430 may include a re-projection unit 431, a difference image generation unit 433, a backprojecion unit 435, and a reconstructed image generation unit 437. Likewise, the re-projection unit 431, the difference image generation unit 433, the backprojecion unit 435, and the reconstructed image generation unit 437 may be implemented as at least one processor.

Referring to FIG. 4, the first intermediate reconstructed image generation unit 410 may take an initial guess, and may generate a first intermediate reconstructed image by applying a first iterated reconstruction algorithm to an original tomographic image. In this example, the initial guess may be mostly taken by performing an initialization process using a backprojecion method.

An example of the first iterated reconstruction algorithm may be a wavelet-based iterated shrinkage algorithm, and a maximum likelihood-expectation maximization (ML-EM) algorithm, a maximum likelihood (ML)-convex algorithm, a simultaneous algebraic reconstruction technique (SART) algorithm, or an algebraic reconstruction technique (ART) algorithm may be alternatively used. Furthermore, the wavelet-based iterated shrinkage algorithm is not limited to an SSF, and another algorithm such as a gradient projection for sparse reconstruction (GPSR) algorithm may also be used. Due to properties of the first iterated reconstruction algorithm, the first intermediate reconstructed image may prevent artifacts caused in a tomographic image obtained at a small angle, and may also prevent noise. On the other hand, the first iterated reconstruction algorithm may possibly lost detailed information. The lost of the detailed information may be compensated by the second intermediate reconstructed image generation unit 430.

The second intermediate reconstructed image generation unit 430 may generate the second intermediate reconstructed image by using the first intermediate reconstructed image and the original tomographic image.

In more detail, the re-projection unit 431 may re-project and transform the first intermediate reconstructed image into a sonogram. The difference image generation unit 433 may generate a difference image by calculating the difference between data extracted from the sonogram and the original tomographic image. The difference image includes noise components, artifact components, and detailed information not reconstructed from the first intermediate reconstructed image (e.g., edge components).

The backprojecion unit 435 may set an initial guess of a signal to be reconstructed, by performing filtered backprojecion or backprojecion on the difference image. The reconstructed image generation unit 437 may generate a second intermediate reconstructed image including edge components by applying a second iterated reconstruction algorithm to the difference image, i.e., a difference sonogram.

In this example, an example of the second iterated reconstruction algorithm may be a total variation regularized reconstruction algorithm. Due to properties of the second iterated reconstruction algorithm, the second intermediate reconstructed image may reconstruct and enhance the detailed information. On the other hand, the second iterated reconstruction algorithm may be sensitive to an initial guess and may possibly distort the contrast of an image.

The composition unit 450 may generate an ultimately reconstructed image by composing the first and second intermediate reconstructed images. In this example, a weighted sum method may be used, or a method of dividing the first and second intermediate reconstructed images into sub-bands by performing directional wavelet transformation such as contourlet transformation, and then combining the sub-bands may also be used.

A technique for processing an image, according to another example embodiment, will now be described. Unlike the method of combining ultimate results of two algorithms in FIG. 4, only portions of two algorithms may be used. In order to solve a noise suppression problem or a deblurring problem, as represented in Equations 1 and 2, a gradient may be calculated by regarding A as an operator for modeling data. However, in tomography, there is a method of updating a solution without calculating a gradient by directly using an operator. Representative examples are an ML-EM method and an ML-convex method. In the ML-EM method and the ML-convex method, an equation for updating a solution one time may be represented as shown in Equations 10 and 11.

$$\begin{matrix}{\hat{x}}_{k + 1} = {\hat{x}}_{k} \cdot ( \frac{- log ( y / N )}{A \hat{{x}_{k}}} ) & 〈 Equation 10 〉 \\ {\hat{x}}_{k + 1} = {\hat{x}}_{k} \cdot ( \frac{{A}^{T} ( \hat{y} * ( 1 + A \hat{{x}_{k}} ) - y )}{{A}^{T} ( A \hat{x} * \hat{y} )} ) , & 〈 Equation 11 〉\end{matrix}$$

Here, ŷ=N exp(−Axₖ).

In Equations 10 and 11, * and / respectively represent multiplication and division between elements. As in Equations 1 and 2, A is a Radon operator. N is the number of X-ray photons emitted from an X-ray source, and may be measured as a maximum value measured in a background from among measured values of y. ŷ is data regenerated by using measured \hat{x}ₖ. After executing Equation 10 or 11, Equation 9 is iterated. In addition to Equation 10 or 11, a well-known update method such as an SART method or an ART method may also be used.

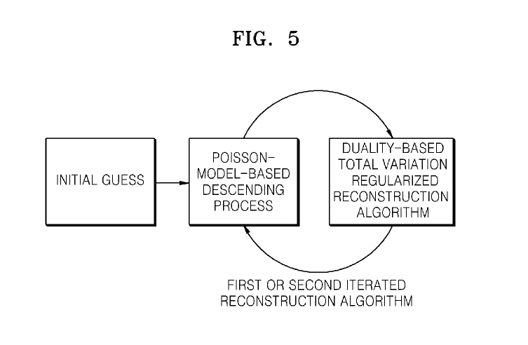

FIG. 5 is a flowchart illustrating a method of processing an image, according to an example embodiment.

A method of processing an image differently from the method illustrated in FIGS. 4 and 5 will now be described. Equations 10 and 11 are calculation performed on each element. In more detail, when an actual cost function to be minimized exists, a new solution for minimizing an approximated cost function is calculated by performing second approximation, and a more accurate approximate expression is iteratively obtained by using the updated solution.

Based on the above fact, it may be regarded that Polynomial 12 is solved in each iteration process.

$${argmin}_{x} ( {x}_{v}^{T} {A}^{T} {Ax}_{v} - 2 {b}_{0}^{T} {x}_{v} + 2 λ {‖ x ‖}_{TV} ) , \qquad 〈 Polynomial 12 〉$$

Here, b=A⁻¹b₀.

In Polynomial 12, xᵥ is a vector formed by sequentially aligning pixels of X. Differently from Equations 1 and 2, A and b are approximate coefficients of cost functions in iteration. Hereinafter, A is referred to as a weight, and b is referred to as an error. A is a diagonal matrix. A and b may be calculated from Equations 10 and 11. A and b in an ML-EM method are represented as shown in Equation 13, and A and b in an ML-convex method are represented as shown in Equation 14.

$$\begin{matrix}diag ( {( {A}^{T} A )}^{- 1} ) = {\hat{x}}_{v} \\ {b}_{0} = {A}^{T} A \hat{x} + ( \frac{- log ( y / N )}{A \hat{{x}_{k}}} - 1 ) & 〈 Equation 13 〉 \\ diag ( {( {A}^{T} A )}^{- 1} ) = \frac{{A}^{T} ( A \hat{x} * \hat{y} )}{\hat{x}} \\ {b}_{0} = {A}^{T} A \hat{x} + {A}^{T} ( \hat{y} - y ) & 〈 Equation 14 〉\end{matrix}$$

A problem of Polynomial 12 may be solved by inducing a dual problem, and may be solved similarly to the method shown in Equation 9. In more detail, the dual problem of Polynomial 12 is represented in Polynomial 15.

$${argmax}_{( p , q ) ∈ 𝒫} {argmin}_{x} ( {x}_{v}^{T} {A}^{T} {Ax}_{v} - 2 {b}_{0}^{T} {x}_{v} + 2 λTr ( {ℒ ( p , q )}^{T} x ) ) \qquad 〈 Polynomial 15 〉$$

Polynomial 15 is the same as Polynomial 16.

$${argmin}_{( p , q ) ∈ 𝒫} {argmin}_{x} {‖ b - λ {A}^{- 1} {ℒ}_{v} ( p , q ) ‖}_{2}^{2} - {‖ {x}_{v} - {A}^{- 1} ( b - λ {A}^{- 1} {ℒ}_{v} ( p , q ) ) ‖}_{2}^{2} \qquad 〈 Polynomial 16 〉$$

The dual problem may be solved by calculating a gradient of Polynomial 16, and updating auxiliary variables p and q. The gradient of Polynomial 16 is represented in Equation 17.

∇h(p,q)=−2λ [symbol] ^{T}(A⁻¹(b−λA⁻¹ [symbol] (p,q))) <Equation 17>

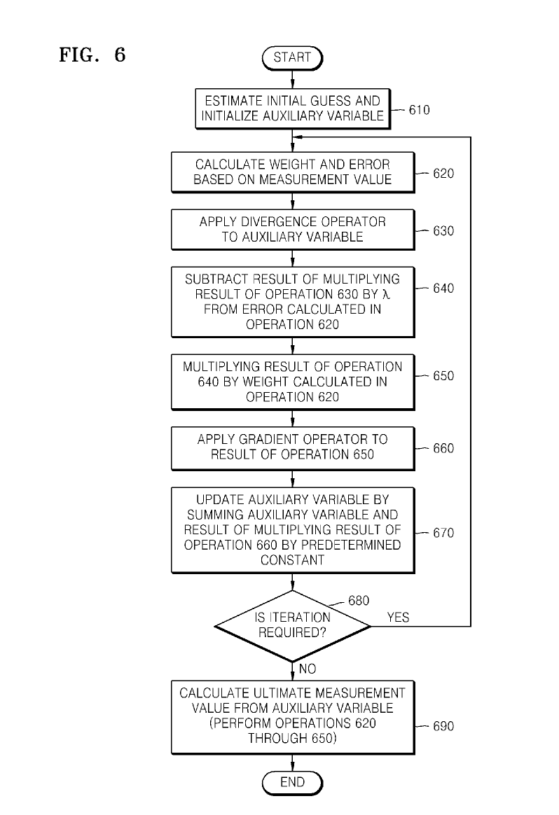

That is, the dual problem may be solved by updating previously calculated (p,q) by adding a result of multiplying Equation 17 by an appropriate parameter to (p,q). The weight A and the error b are updated by using the updated (p,q) and Equation 13 or 14. Then, Equation 17 is iterated. The above method is illustrated in FIG. 6.

As described above, according to one or more of the above embodiments of the present invention, aliasing and artifacts occurring in a tomographic image obtained from a predetermined subject in a limited range of angles may be reduced. Accordingly, the amount of information required to ultimately compose tomographic images may be reduced, the amount of radiation exposed to a subject may be reduced, the number of required view images may be reduced, and an image capturing time is also reduced.

Also, blurring in a depth direction may be reduced by using an iterated reconstruction algorithm. Furthermore, artifacts of a sparse view image may be prevented. Besides, a complicated L1 minimization problem and a total variation regularized problem may be rapidly solved by using a modified iterated shrinkage algorithm, and a high operational speed may be achieved by using a graphics processing unit (GPU).

In addition, other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing an image, the method comprising:
generating a first intermediate reconstructed image by applying a first iterated reconstruction algorithm to a tomographic image of a predetermined subject;
generating a second intermediate reconstructed image by applying a second iterated reconstruction algorithm to a difference image between the first intermediate reconstructed image and the tomographic image; and
generating an ultimately reconstructed image by composing the first and second intermediate reconstructed images.

2. The method of claim 1, wherein the first iterated reconstruction algorithm is a wavelet-based iterated shrinkage algorithm, a maximum likelihood-expectation maximization (ML-EM) algorithm, a maximum likelihood (ML)-convex algorithm, a simultaneous algebraic reconstruction technique (SART) algorithm, or an algebraic reconstruction technique (ART) algorithm.

3. The method of claim 1, wherein the second iterated reconstruction algorithm is a total variation regularized reconstruction algorithm.

4. The method of claim 1, wherein the generating of the second intermediate reconstructed image comprises:
re-projecting and transforming the first intermediate reconstructed image into a sonogram;
generating a difference image by calculating a difference between data extracted from the sonogram and the tomographic image;
setting an initial guess of a signal to be reconstructed, by performing backprojecion on the difference image; and
generating the second intermediate reconstructed image including edge components by applying the second iterated reconstruction algorithm to the difference image.

5. The method of claim 4, wherein the difference image comprises noise components, artifact components, and detailed information not reconstructed from the first intermediate reconstructed image.

6. The method of claim 1, wherein the generating of the ultimately reconstructed image comprises generating the ultimately reconstructed image by calculating a weighted sum of the first and second intermediate reconstructed images, or by dividing the first and second intermediate reconstructed images into sub-bands by performing directional wavelet transformation, and then combining the sub-bands.

7. An apparatus for processing an image, the apparatus comprising:
a first intermediate reconstructed image generation unit to generate a first intermediate reconstructed image by applying a first iterated reconstruction algorithm to a tomographic image of a predetermined subject;
a second intermediate reconstructed image generation unit to generate a second intermediate reconstructed image by applying a second iterated reconstruction algorithm to a difference image between the first intermediate reconstructed image and the tomographic image; and
a composition unit to generate an ultimately reconstructed image by composing the first and second intermediate reconstructed images.

8. The apparatus of claim 7, wherein the first iterated reconstruction algorithm is a wavelet-based iterated shrinkage algorithm, a maximum likelihood-expectation maximization (ML-EM) algorithm, a maximum likelihood (ML)-convex algorithm, a simultaneous algebraic reconstruction technique (SART) algorithm, or an algebraic reconstruction technique (ART) algorithm.

9. The apparatus of claim 7, wherein the second iterated reconstruction algorithm is a total variation regularized reconstruction algorithm.

10. The apparatus of claim 7, wherein the second intermediate reconstructed image generation unit re-projects and transforms the first intermediate reconstructed image into a sonogram, generates a difference image by calculating a difference between data extracted from the sonogram and the tomographic image, sets an initial guess of a signal to be reconstructed, by performing backprojection on the difference image, and generates the second intermediate reconstructed image including edge components by applying the second iterated reconstruction algorithm to the difference image.

11. The apparatus of claim 10, wherein the difference image comprises noise components, artifact components, and detailed information not reconstructed from the first intermediate reconstructed image.

12. The apparatus of claim 7, wherein the composition unit generates the ultimately reconstructed image by calculating a weighted sum of the first and second intermediate reconstructed images, or by dividing the first and second intermediate reconstructed images into sub-bands by performing directional wavelet transformation, and then combining the sub-bands.

13. A method of processing an image, the method comprising:
calculating an initial guess of a tomographic image of a predetermined subject;
updating the initial guess by using an update method induced from a data obtaining model of an X-ray, and rapidly removing noise by using a gradient-based total variation regularization method; and
iterating the updating and the rapid removing.

14. The method of claim 13, wherein the update method induced from the data obtaining model of the X-ray is a maximum likelihood-expectation maximization (ML-EM) algorithm, a maximum likelihood (ML)-convex algorithm, a simultaneous algebraic reconstruction technique (SART) algorithm, or an algebraic reconstruction technique (ART) algorithm.

15. A medical image system having an apparatus for processing an image, the apparatus comprising:
a first intermediate reconstructed image generation unit to generate a first intermediate reconstructed image by applying a first iterated reconstruction algorithm to a tomographic image of a predetermined subject;
a second intermediate reconstructed image generation unit to generate a second intermediate reconstructed image by applying a second iterated reconstruction algorithm to a difference image between the first intermediate reconstructed image and the tomographic image; and
a composition unit to generate an ultimately reconstructed image by composing the first and second intermediate reconstructed images.

16. The medical image system of claim 15, further comprising a tomography unit to obtain the tomographic image of the predetermined subject.

17. The medical image system of claim 15, further comprising a storage unit to store the generated ultimately reconstructed image, or to store diagnosis information obtained from the generated ultimately reconstructed image, in correspondence with the ultimately reconstructed image.

18. The medical image system of claim 15, further comprising a communication unit to transmit the generated ultimately reconstructed image, or to transmit diagnosis information obtained from the generated ultimately reconstructed image, in correspondence with the ultimately reconstructed image.

19. A non-transitory computer-readable recording medium having recorded thereon a computer program for executing the method of claim 1.
